(19) United States
(12) Patent Application Publication
(10) Pub. No.: US 2014/0152109 A1
(43) Pub. Date: Jun. 5, 2014

(54) MEDIUM VOLTAGE UNINTERRUPTIBLE POWER SUPPLY

(71) Applicant: GENERAL ELECTRIC COMPANY, Schenectady, NY (US)

(72) Inventors: Viswanathan Kanakasabai, Bangalore (IN); Rajendra Naik, Bangalore (IN); Silvio Colombi, Losone (CH); Said Farouk Said El-Barbari, Freising (DE); Pradeep Vijayan, Bangalore (IN)

(73) Assignee: GENERAL ELECTRIC COMPANY, Schenectady, NY (US)

(21) Appl. No.: 13/689,776

(22) Filed: Nov. 30, 2012

(51) Int. Cl. H02J 9/00

(52) U.S. Cl. CPC H02J 9/00
USPC 307/66; 307/64

(57) ABSTRACT

A medium voltage uninterruptible power supply system is presented. The system includes a first power converter coupled between a first bus and a second bus. Furthermore, a second power converter operatively coupled to the first power converter via the first bus and the second bus, where the second power converter includes at least three legs, where the at least three legs include a plurality of switching units, and where the plurality of switching units includes at least two semiconductor switches and an energy storage device. Additionally, system includes a direct current link coupled between the first bus and the second bus. Also, system includes an energy source coupled to the second power converter, the direct current link, or a combination thereof via one or more of a third power converter, a transformer, and a fourth power converter. Method of operating a medium voltage uninterruptible power supply system is also presented.

### BACKGROUND

Embodiments of the present disclosure relate generally to uninterruptible power supplies and more specifically to uninterruptible power supplies realized with medium voltage converters.

Traditionally, uninterruptible power supplies have been used in many applications such as data centers and hospitals to provide uninterrupted power to the load during outages/disturbances in the AC mains supply voltage. Typically, these uninterruptible power supply are rated to receive AC supply voltage from a low voltage (380 V-480 V) distribution network and supply a three phase voltage at the same voltage levels to the load. Additionally, the uninterruptible power supply generally includes a power converter for power conversion, a capacitor for storing electrical energy, a switching means, an energy source, and a controller. Also, conventional power converters include one or more single stage converters.

In recent times, the size of the data centers has increased considerably. Hence, supplying loads through a low voltage uninterruptible power supply is a challenge and therefore, it is economical to employ a medium voltage uninterruptible power supply. The medium voltage uninterruptible power supply process power at a higher voltage resulting in a lower value of current to be handled by the uninterruptible power supply and cables coupling the uninterruptible power supply and the load. This lower value of current reduces cabling and installation costs, and the operating cost of the data centers.

### BRIEF DESCRIPTION

In accordance with aspects of the present disclosure, a medium voltage uninterruptible power supply system is presented. The system includes a first power converter operatively coupled between a first bus and a second bus. Also, the system includes a second power converter operatively coupled to the first power converter via the first bus and the second bus, where the second power converter includes at least three legs, where the at least three legs include a plurality of switching units, and where the plurality of switching units includes at least two semiconductor switches and an energy storage device. Additionally, the system includes a direct current link operatively coupled between the first bus and the second bus. Furthermore, the system includes an energy source operatively coupled to the second power converter, the direct current link or both the second power converter and the direct current link via one or more of a third power converter, a transformer, and a fourth power converter.

In accordance with another aspect of the present disclosure, a method for operating a medium voltage uninterruptible power supply system is presented. The method includes coupling a first power converter to a second power converter via a first bus and a second bus, where the second power converter includes at least three legs, where the at least three legs include a plurality of switching units, and where the plurality of switching units includes at least two semiconductor switches and an energy storage device. Also, the method includes connecting a direct current link between the first bus and the second bus. Additionally, the method includes operatively coupling an energy source to the second power converter, the direct current link, or both the second power converter and the direct current link via one or more of a third power converter, a transformer, and a fourth power converter. Furthermore, the method includes determining a switching pattern for the plurality of switching units in the second power converter and generating an output at the second power converter based on the switching pattern of the plurality of switching units of the second power converter.

In accordance with yet another aspect of the present disclosure, a medium voltage uninterruptible power supply system, is presented. The system includes a first power converter operatively coupled between a first bus and a second bus. Moreover, the system includes a second power converter operatively coupled to the first power converter via the first bus and the second bus, where the second power converter includes at least three legs, where the at least three legs include a plurality of switching units, and where the plurality of switching units includes at least two semiconductor switches and an energy storage device. Furthermore, the system includes a direct current link operatively coupled between the first bus and the second bus, where the direct current link includes a plurality of capacitors operatively coupled in series. In addition, the system includes an energy source operatively coupled to the plurality of capacitors of the direct current link, each of the plurality of switching units of the second power converter, or a combination thereof via one or more of a third power converter, a transformer, and a fourth power converter.

### DRAWINGS

These and other features, aspects, and advantages of the present disclosure will become better understood when the following detailed description is read with reference to the accompanying drawings in which like characters represent like parts throughout the drawings, wherein:

FIG. 1 is a diagrammatical representation of a medium voltage uninterruptible power supply system, in accordance with aspects of the present disclosure;

FIG. 2 is a diagrammatical representation of a portion of the medium voltage uninterruptible power supply system of FIG. 1;

FIG. 3 is a diagrammatical representation of another exemplary embodiment of a portion of the medium voltage uninterruptible power supply system of FIG. 1, according to aspects of the present disclosure;

FIG. 4 is a diagrammatical representation of yet another exemplary embodiment of a portion of the medium voltage uninterruptible power supply system of FIG. 1, according to aspects of the present disclosure;

FIG. 5 is a diagrammatical representation of another exemplary embodiment of a portion of the medium voltage uninterruptible power supply system of FIG. 1, according to aspects of the present disclosure;

FIG. 6 is a diagrammatical representation of yet another exemplary embodiment of a portion of the medium voltage uninterruptible power supply system of FIG. 1, according to aspects of the present disclosure;

FIG. 7 is a diagrammatical representation of another exemplary embodiment of a portion of the medium voltage uninterruptible power supply system of FIG. 1, according to aspects of the present disclosure;

FIG. 8 is a diagrammatical representation of yet another exemplary embodiment of a portion of the medium voltage uninterruptible power supply system of FIG. 1, according to aspects of the present disclosure; and

FIG. 9 is a flow chart representing a method of power conversion using the medium voltage uninterruptible power supply system of FIG. 1, according to aspects of the present disclosure.

### DETAILED DESCRIPTION

Unless defined otherwise, technical and scientific terms used herein have the same meaning as is commonly understood by one of ordinary skill in the art to which this disclosure belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and mean one, some, or all of the listed items. The use of “including,” “comprising” or “having” and variations thereof herein are meant to encompass the items listed thereafter and equivalents thereof as well as additional items. The terms “connected” and “coupled” are not restricted to physical or mechanical connections or couplings, and can include electrical connections or couplings, whether direct or indirect. Furthermore, the terms “circuit” and “circuitry” and “controller” may include either a single component or a plurality of components, which are either active and/or passive and are connected or otherwise coupled together to provide the described function.

As will be described in detail hereinafter, various embodiments of an exemplary uninterruptible power supply (UPS) system and method for uninterruptible power supply are presented. In particular, a medium voltage uninterruptible power supply (MV-UPS), is presented. Also, the MV-UPS may be configured to receive as input a medium voltage at an alternating current (AC) main and supply a medium voltage output to a load. It may be noted that the medium voltage output to the load may be routed via a voltage matching transformer, in some embodiments. In one example, the medium voltage at the AC main may range from 3.3 kV to 20 kV. In one example, the MV-UPS may include a medium voltage converter such as a modular multilevel converter. The term modular multilevel converter, as used herein, is used to refer to a power converter with a plurality of switching units/modules and configured to generate a multilevel output voltage with very low distortion.

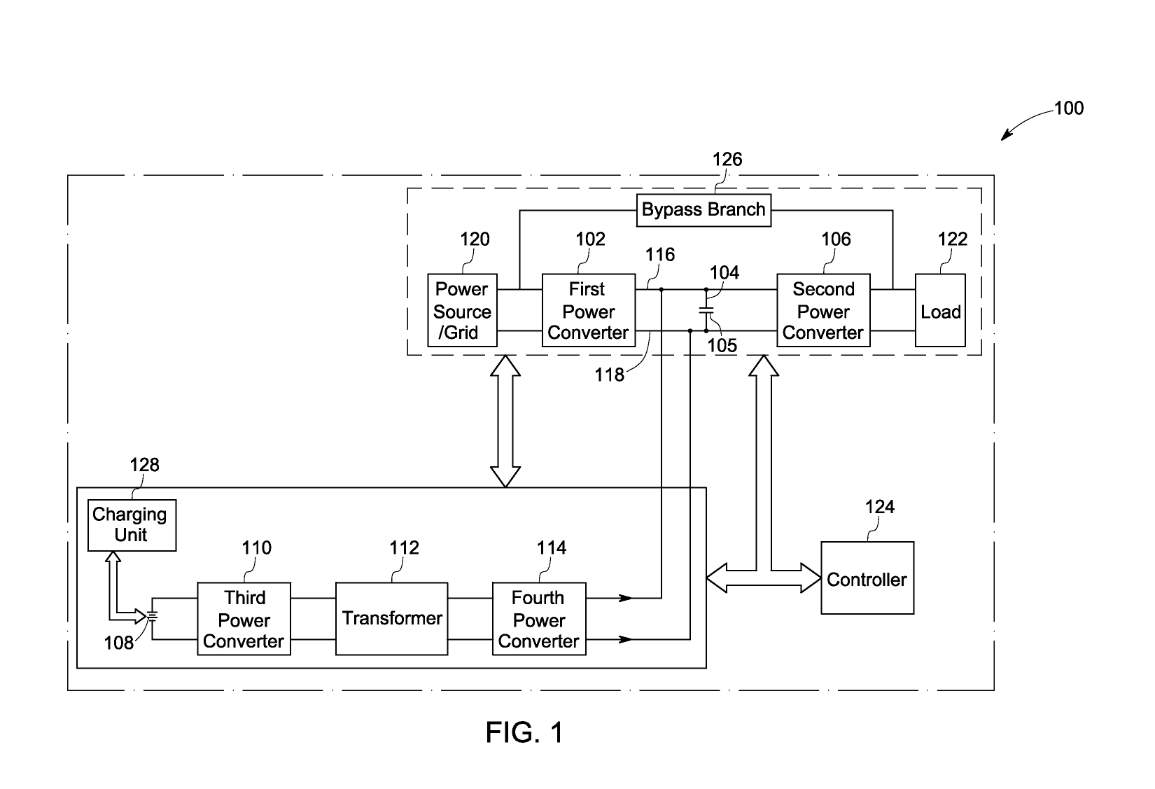

Turning now to the drawings, by way of example in FIG. 1, an embodiment of an medium voltage uninterruptible power supply (MV-UPS) system 100 for supplying power, in accordance with aspects of the present disclosure, is depicted. In one embodiment, the MV-UPS system 100 may include a first power converter 102, a direct current (DC) link 104, a second power converter 106, and an energy source 108. The first power converter 102 and the second power converter 106 may include three legs, in one example. Each of the three legs may include a plurality of switching units (not shown) operatively coupled in series. In one example, each of the plurality of switching units may include at least two semiconductor switches and an energy storage device. The MV-UPS system 100 is configured to use low voltage semiconductor switches and this aids in reducing the cost of the MV-UPS systems.

Additionally the MV-UPS system 100 may also include a third power converter 110, a transformer 112, and a fourth power converter 114. The first power converter 102, the second power converter 106, the third power converter 110, and the fourth power converter 114 may include a direct current (DC) to DC converter, a DC to AC (alternating current) converter, an AC to DC converter, and the like. The first power converter 102 and the second power converter 106 may include a multilevel converter. In one non-limiting example, the first power converter 102 and the second power converter 106 may include a modular multilevel converter (MMC). Also, the first power converter 102 may include a rectifier and the second power converter 106 may include an inverter, in one embodiment. Furthermore, the third power converter 110 may include a low frequency resonant converter, a high frequency phase shifted resonant converter, an unidirectional converter, a bidirectional converter, and the like. Also, the fourth power converter 114 may include a rectifier, a bidirectional power converter, a unidirectional power converter, and equivalents thereof. Moreover, the third power converter 110 and the fourth power converter 114 may include a plurality of semiconductor switches, such as, but not limited to, silicon based switches, silicon carbide based switches, gallium arsenide based switches, and gallium nitride based switches.

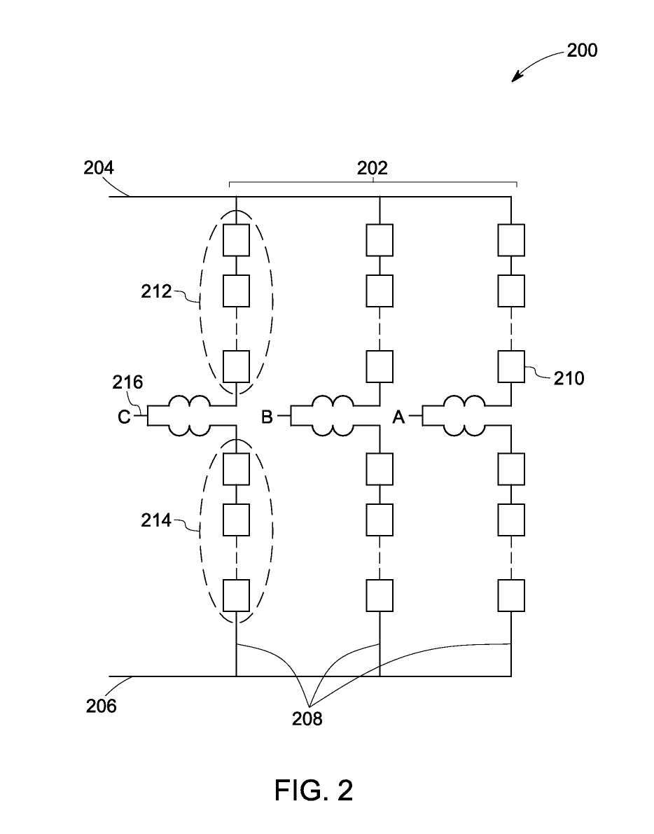

Moreover, the first power converter 102 may be operatively coupled to the second power converter 106 via a first bus 116 and a second bus 118. The first bus 116 may include a positive direct current bus and the second bus 118 may include a negative direct current bus. The topology of the first power converter 102 and the second power converter 106 will be explained in greater detail with reference to FIG. 2. During normal operating conditions, a power source 120 may be employed to supply power to the first power converter 102. The term power source 120, as used herein, may include a renewable power source, a non-renewable power source, a generator, a grid, and the like. Furthermore, the second power converter 106 may be operatively coupled to a load 122. For example, in a data center, the load 122 may include a server load. The medium voltage from the MV-UPS 100 may be stepped down by a downstream transformer (not shown) at the load 122 to reduce the voltage to a desired voltage, in some embodiments.

The first power converter 102 may be operatively coupled to the second power converter 106 via the first bus 116 and the second bus 118. Also, a DC link 104 may be operatively coupled across the first bus 116 and the second bus 118. In one example, the DC link 104 may include a DC link capacitor 105. In another example, the DC link 104 may include a plurality of capacitors operatively coupled in series. It may be noted that in yet another embodiment, the DC link 104 may be an open branch between the first bus 116 and the second bus 118. The term operatively coupled, as used herein, includes wired coupling, wireless coupling, electrical coupling, magnetic coupling, radio communication, software based communication, or combinations thereof.

As noted hereinabove, the MV-UPS system 100 may include the energy source 108. By way of example, the energy source 108 may include a low voltage battery of 600 volts rating. The energy source 108 may be operatively coupled to the first power converter 102 and the second power converter 106. In a presently contemplated configuration, the energy source 108 may be coupled to the first power converter and the second power converter via the third power converter 110, the transformer 112, and the fourth power converter 114. The transformer 112 aids in boosting the voltage supplied by the energy source 108. In one example, the transformer 112 may include a primary winding and one or more secondary windings. Moreover, the transformer 112 may include a low frequency transformer, a high frequency transformer, a graded insulation transformer, a transformer with uniform insulation, a single phase transformer, a three phase transformer, a multi-phase transformer, a multiple-winding transformer, or combinations thereof. Also, in one example, the MV-UPS system 100 may include a plurality of transformers 112.

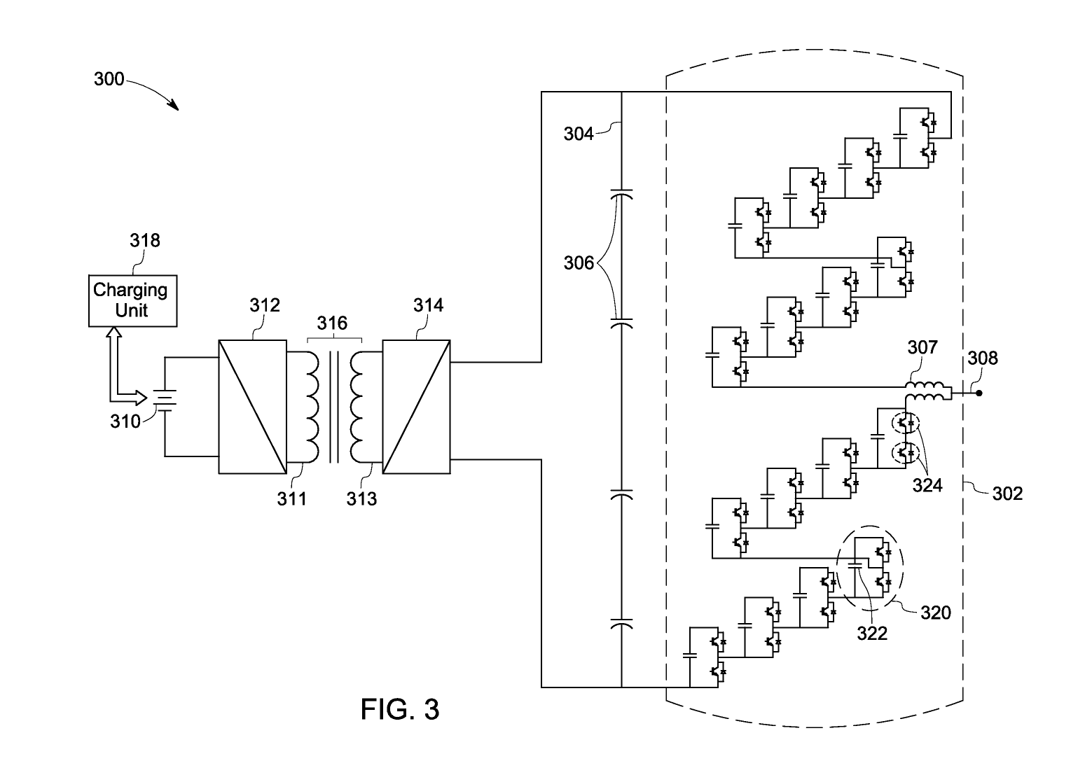

Furthermore, as depicted in the example of FIG. 1, an output of the fourth converter 114 may be coupled between the first bus 116 and the second bus 118. In particular, the output of the fourth power converter 114 may be coupled across the DC link 104 disposed between the first bus 116 and the second bus 118. In another example, the output of the fourth power converter 114 may be operatively coupled to the switching units (not shown) in the second power converter 106. The topology of coupling the fourth converter across the DC link 104 and/or to the switching units in the second power converter 106 will be explained in greater detail with reference to FIGS. 3-8.

Additionally, the system 100 may include a controller 124. The controller 124 may be configured to control the operation of the power converters 102, 106, 110 and 114, in one embodiment. More particularly, in one example, the controller 124 may be configured to control the operation of the power converters 102, 106, 110 and 114 by controlling the switching of the plurality of semiconductor switches corresponding to these power converters. The controller 124 may be configured to generate the switching pattern for the power converters 102, 106, 110 and 114 based on a reference voltage and/or a reference current. By way of example, the controller 124 may be configured to determine a switching pattern corresponding to the plurality of switching units of the first power converter 102 and the plurality of switching units of the second power converter 106. In one embodiment, the controller 124 may be disposed outside the MV-UPS system 100 at a remote location. Moreover, the controller 124 may also be configured to operate multiple MV-UPS systems that are arranged in a parallel configuration.

Also, the system 100 may include a bypass branch 126 operatively coupled across the first power converter 102 and the second power converter 106. The bypass branch 126 may include an electromechanical switch, a semiconductor switch, or a combination thereof. The semiconductor switch of the bypass branch 126 may be capable of withstanding a medium voltage. In one example, the bypass branch 126 may include a stacked connection of semiconductor switches having a low voltage rating. This stacked connection of semiconductor switches may form a bidirectional AC bypass switch and may be configured to withstand the medium voltage. In addition, the bypass branch 126 may be configured to overcome faults occurring in the power converters 102, 106.

Moreover, in one example, if the fourth power converter 114 is a bidirectional converter, the energy source 108 may be charged using the power source 120. In particular, the energy source 108 may be charged using the power source 120 via the first power converter 102, the DC link 104, the fourth power converter 114, the transformer 112, and the third power converter 110. However, if the fourth power converter 114 is a rectifier or a unidirectional converter, the energy source 108 may be charged using a charging unit 128. The charging unit 128 may include a standalone power converter, in one example.

Referring now to FIG. 2, a diagrammatical representation 200 of a portion of the MV-UPS system 100 of FIG. 1 is depicted. Particularly, FIG. 2 is a diagrammatic representation of a power converter 202, such as the second power converter 106 of FIG. 1. The power converter 202 may be operatively coupled between a first bus 204 and a second bus 206. Also, the power converter 202 may include at least three legs 208. Each of the three legs 208 of the power converter 202 may be associated with an alternating current phase such as AC phase-A, AC phase-B, and AC phase-C. It may be noted that the power converter 202 may include two legs in case of the MV-UPS system with a single phase load.

Moreover, each of the three legs 208 corresponding to the power converter 202 may include a plurality of switching units 210. The plurality of switching units 210 may be operatively coupled in series. In one example, the plurality of switching units 210 may include at least two semiconductor switches and an energy storage device. The three legs 208 may include a first portion 212 operatively coupled to a second portion 214. In each leg 208, the first portion 212 may be operatively coupled to the second portion 214 via a third bus 216. The third bus 216 may include an alternating current phase. It may be noted a topology of the first power converter 102 of FIG. 1 may be substantially similar or equivalent to the topology of the power converter 202.

FIG. 3 is a diagrammatical representation 300 of an exemplary embodiment of a portion of the MV-UPS system 100 of FIG. 1, according to aspects of the present disclosure. It may be noted that FIG. 3 depicts a coupling of an energy source across a DC link. As depicted in FIG. 3, the system 300 includes one leg 302 of a power converter, such as the second power converter 106 of FIG. 1. For ease of representation, only one leg 302 of the power converter is depicted. The leg 302 may be operatively coupled across a DC link 304. The DC link 304 may include a plurality of DC link capacitors 306. Also, the leg 302 may be operatively coupled to a third bus 308 via an inductor 307. In one example, the inductor 307 may include a split inductor, two inductors in series, and the like. The third bus 308 may include an alternating current phase.

Furthermore, the leg 302 may include a plurality of switching units 320 operatively coupled in series. Each switching unit 320 may include at least two fully controllable semiconductor switches 324 and an energy storage device 322. In one example, an operating DC voltage across the energy storage device 322 may be around 800 volts. It may be desirable to use fully controllable semiconductor switches having a higher voltage rating than the operating DC voltage. By way of example, the two fully controllable semiconductor switches 324 may each be rated to a voltage of about 1200 volts DC, in order to withstand the voltage of 800 volts across the energy storage device. Accordingly, the voltage across each of switching units may be 800 volts. Furthermore, in this example, it may be assumed that the value of voltage across the DC link 304 is high, for example 6400 volts. Also, for effective control of the power converter, both halves of the leg 302 may have to withstand a voltage of 6400 V across the DC link 304. To that end, it may be desirable to include 8 switching units in each half of the leg 302 to withstand the 6400 volts of DC link voltage. Thus, the leg 302 of the power converter may include a total of 16 switching units.

Furthermore, the configuration of the leg 302 with 16 switching units may aid in the generation of nine levels of phase voltage. In the example of FIG. 3, the nine levels of phase voltage may be generated by activating 8 switching units of the 16 switching units corresponding to the leg 302 in a sequential pattern. Accordingly, seventeen levels of line to line voltage may be generated at an output terminal (not shown) of the second power converter. Although the example of FIG. 3 depicts the switching units 320 as including two fully controllable semiconductor switches 324 and one energy storage device 322, use of other numbers of fully controllable semiconductor switches and energy storage devices is also contemplated.

Furthermore, the system 300 may include an energy source 310 operatively coupled to a third converter 312 such as the third power converter 110 of FIG. 1. The energy source 310 may include a battery of 600 volts rating. In one non-limiting example, the energy source 310 may include a single battery, multiple batteries operatively coupled in parallel or series, and the like. Also, the third converter 312 may be operatively coupled to a fourth power converter 314, such as the fourth power converter 114 of FIG. 1, via a transformer 316. As previously noted, the transformer 316 may include a low frequency transformer, a high frequency transformer, a graded insulation transformer, a transformer with uniform insulation, a single phase transformer, a three phase transformer, a multi-phase transformer, a multiple-winding transformer, and the like.

Moreover, in one example, the fourth power converter 314 may include a bidirectional converter. Hence, the bidirectional converter 314 may be configured to either supply power to the DC link 304 in a first mode of operation or in a second mode of operation, the bidirectional converter 314 may be configured to receive power from the DC link 304 to charge the energy source 310. More particularly, in the second mode of operation, the energy source 310 may be charged via the first power converter, the DC link 304, the bidirectional converter 314, the transformer 316, and the third power converter 312. The first mode of operation may be referred to as a backup mode of operation and the second mode of operation may also be referred to as an utility mode of operation.

In yet another embodiment, the fourth power converter 314 may include a rectifier or a unidirectional converter. The use of the rectifier or the unidirectional converter allows supply of power in one direction only. More particularly, the power may be supplied from the energy source 310 to the DC link 304. Hence, in this example, the rectifier or the unidirectional converter 314 may not be used to charge the energy source 310. Accordingly, it may be desirable to use a charging unit 318 to charge the energy source 310. As noted hereinabove, the charging unit 318 may include a standalone power converter.

Furthermore, in the example of FIG. 3, the transformer 316 may include a primary winding 311 and a secondary winding 313. The secondary winding side of the transformer 316 may include components, such as, but not limited to, the fourth power converter 314 and plurality of switching units 320. It may be desirable to isolate the components on the secondary winding side of the transformer 316 to withstand the high voltage across the DC link 304. Furthermore, each of the switching units 320 corresponding to the leg 302 may be isolated from the other switching units 320.

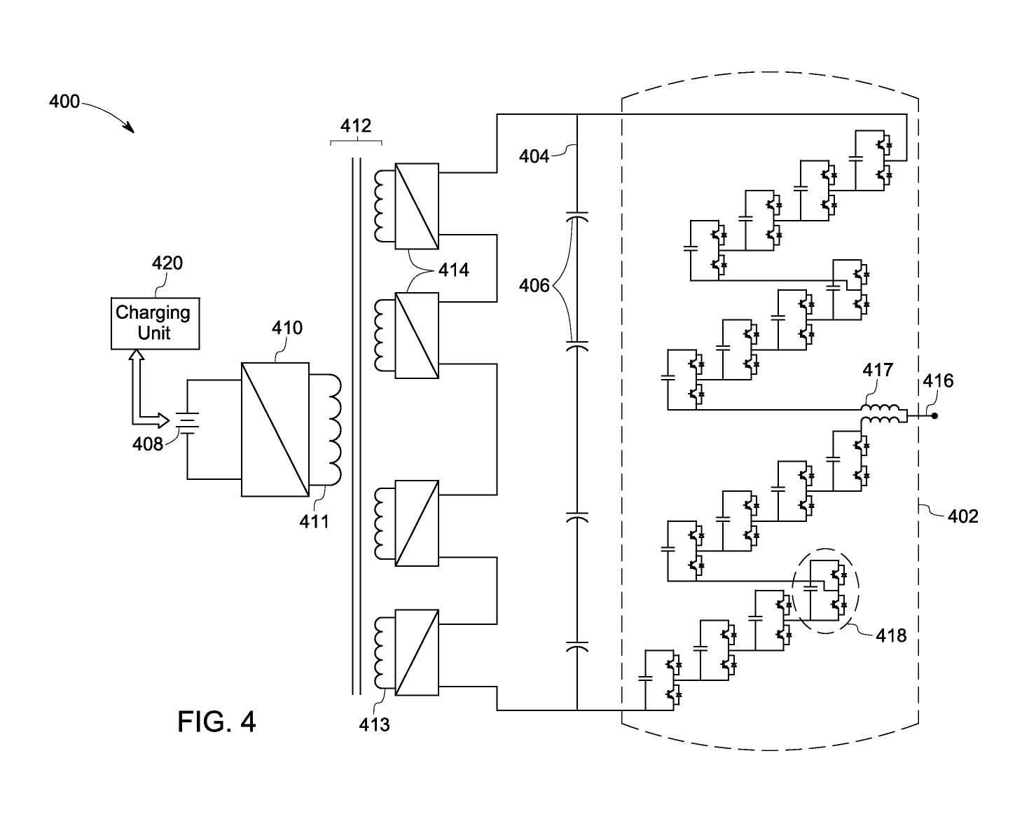

Turning now to FIG. 4, a diagrammatical representation 400 of another exemplary embodiment of a portion of the MV-UPS system 100 of FIG. 1, according to aspects of the present disclosure, is depicted. The system 400 depicted in FIG. 4 may include a leg 402 of the power converter, such as the leg 208 of the power converter 202 of FIG. 2. The leg 402 may include a plurality of switching units 418 operatively coupled in series. Also, the leg 402 may be operatively coupled to a DC link 404. The DC link 404 may include a plurality of capacitors 406 operatively coupled in series. In the example of FIG. 4, the DC link 404 is shown as including four capacitors 406 coupled in series.

Moreover, the system 400 may include an energy source 408. As noted hereinabove, the energy source 408 may include a single battery of 600 volt rating, multiple batteries operatively coupled in parallel and/or series, and the like. The energy source 408 may be operatively coupled to a third power converter 410 such as the third power converter 110 of FIG. 1. Furthermore, the third power converter 410 may be operatively coupled to a transformer 412. The transformer 412 may include a primary winding 411 and a secondary winding 413. In the presently contemplated configuration of FIG. 4, the transformer 412 may include a plurality of secondary windings 413. Additionally, the system 400 may also include a plurality of fourth power converters 414, such as the fourth power converter 114 of FIG. 1. Also, each secondary winding 413 may be coupled to a corresponding fourth power converter 414.

However, in another embodiment, the secondary winding 413 of the transformer 412 may have a plurality of taps. In this embodiment, each section of the multiple tap transformer may be coupled to a corresponding fourth power converter 414. In the example of FIG. 4, the fourth power converters 414 may be connected in series to build up the voltage across the DC link 404. Also, each of the fourth power converter 414 may be isolated to withstand the voltage across the DC link 404. The fourth power converters 414 may include a bidirectional converter and/or an unidirectional converter, as noted hereinabove. In the embodiment where all the fourth power converters 414 include an unidirectional converter, the system 400 may also include a charging unit 420 configured to charge the energy source 408. In addition, the leg 402 may be operatively coupled to a third bus 416 via an inductor 417.

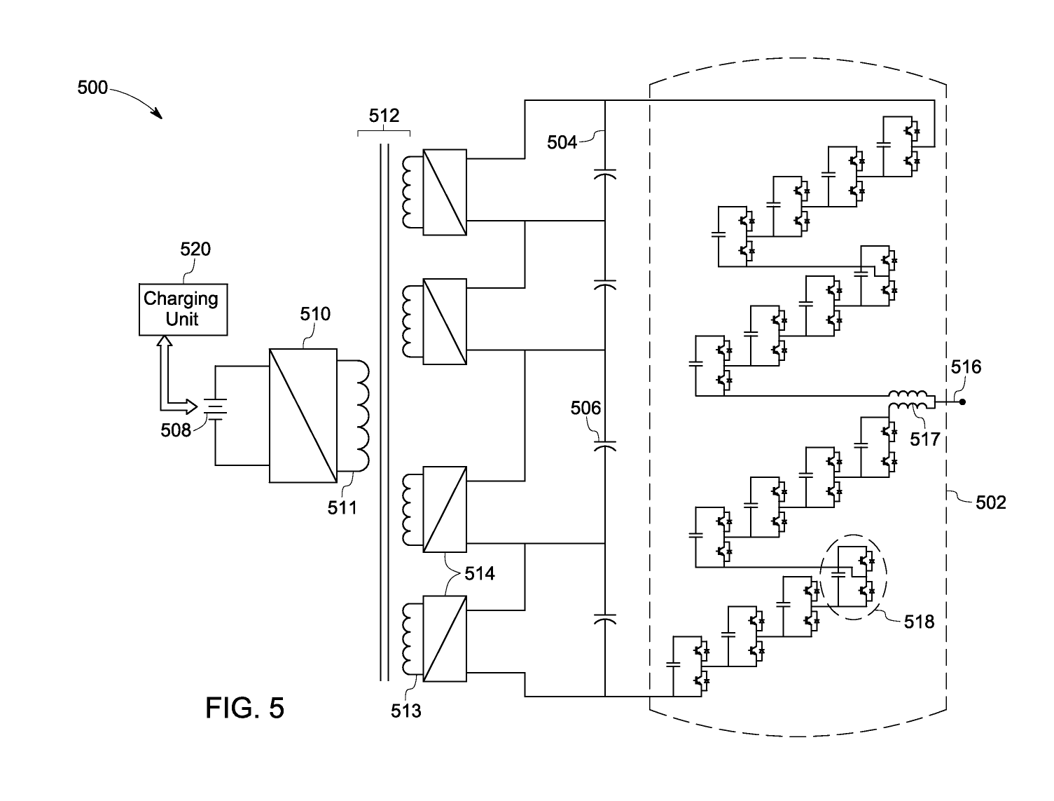

Referring to FIG. 5, a diagrammatical representation 500 of yet another exemplary embodiment of a portion of the MV-UPS system 100 of FIG. 1, according to aspects of the present disclosure, is depicted. The embodiment of FIG. 5 is substantially similar to the embodiment of FIG. 4. In the example of FIG. 5, a leg 502 of a power converter may be operatively coupled to a DC link 504. The DC link 504 may include a plurality of DC link capacitors 506 operatively coupled in series. An energy source 508 may be operatively coupled to a third power converter 510.

The system 500 may also include a plurality of fourth power converters 514. Furthermore, the third power converter 510 may be operatively coupled to a transformer 512. The transformer 512 may include a primary winding 511 and a secondary winding 513. In the example of FIG. 5, the transformer 512 may include plurality of secondary windings 513, where each secondary winding 513 may be configured to supply power to a corresponding fourth power converter 514. Alternatively, the secondary winding 513 of the transformer 512 may have multiple taps and each section of the multiple tap transformer may be coupled to a corresponding fourth power converter 514. Furthermore in the example of FIG. 5, each fourth power converter 514 may be coupled across a corresponding DC link capacitor 506. In addition, the fourth power converters 514 may be operatively coupled to each other in series.

In addition, the leg 502 may be operatively coupled to a third bus 516 via an inductor 517. The leg 502 may also include a plurality of switching units 518 operatively coupled in series. In one embodiment, the energy source 508 may be charged using a charging unit 520.

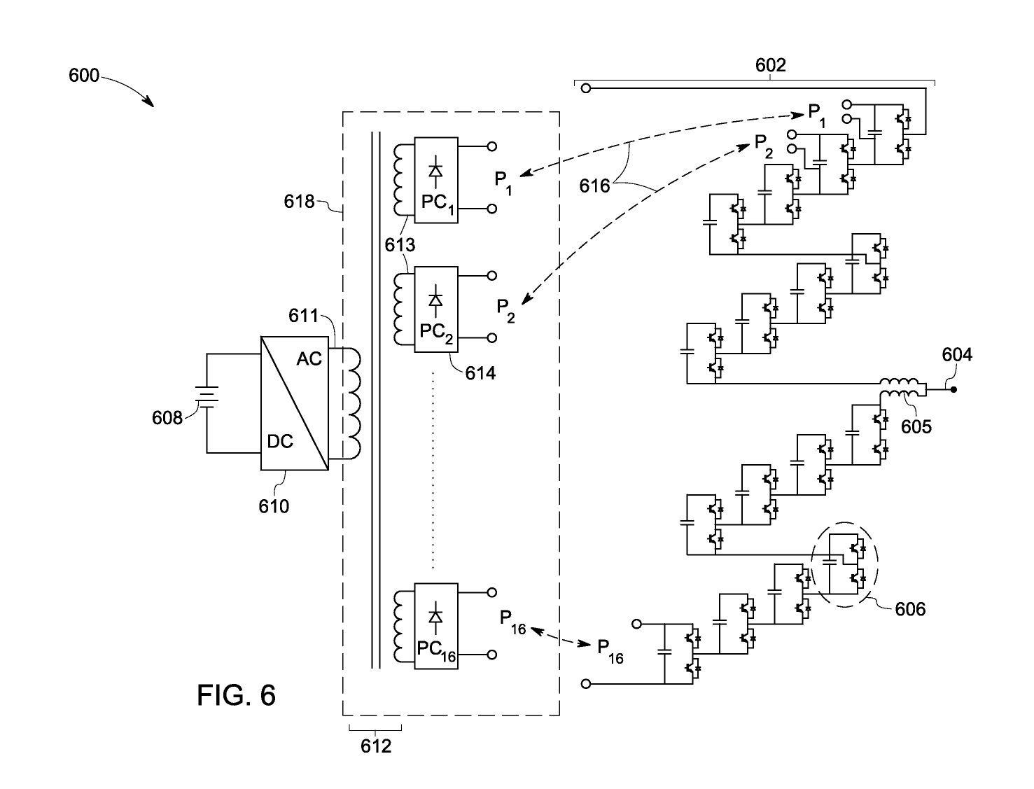

FIG. 6 is a diagrammatical representation 600 of yet another exemplary embodiment of a portion of the MV-UPS system 100 of FIG. 1, according to aspects of the present disclosure. In the example of FIG. 6, a leg 602 of a power converter may be operatively coupled to a third bus 604 via an inductor 605. In one example, the third bus 604 may include an alternating current phase, such as AC phase A, AC phase B, and AC phase C. The leg 602 may include a plurality of switching units 606 operatively coupled in series. Furthermore, the system 600 may include an energy source 608. The energy source 608 may include a single battery, multiple batteries coupled in series and/or parallel, and equivalents thereof.

Also, the energy source 608 may be operatively coupled to a third power converter 610. The transformer 612 may include a primary winding 611 and a plurality of secondary windings 613. The third power converter 610 may be operatively coupled to a primary winding 611 of the transformer 612. In the example of FIG. 6, the system 600 includes a plurality of fourth power converters 614. Each of the plurality of secondary windings 613 may be operatively coupled to a corresponding fourth power converter 614. Furthermore, each fourth power converter 614 may be coupled to a corresponding switching unit 606. In one example, the number of fourth power converters 614 and the number of switching units 606 in one leg 602 may be substantially equal. By way of example, the leg 602 includes 16 fourth power converters 614 and 16 switching units 606 in one leg 602. More particularly, each switching unit 606 may have a corresponding fourth power converter 614.

For ease of representation, the 16 fourth power converters 614 corresponding to the leg 602 are depicted as PC₁-PC₁₆. In the example of FIG. 6, terminals P₁ and P₂ of the fourth power converters PC₁ and PC₂ may be operatively coupled to the corresponding terminals P₁ and P₂ of the individual switching units 606. The fourth power converter 614 may be operatively coupled to the individual switching units 606 using a high voltage cable 616, in one embodiment. Although FIG. 6 represents only one leg 602, in a three phase MV-UPS system the power converter may include three legs. As noted hereinabove, each of the three legs may include 16 switching units and therefore the three legs may include a total of 48 switching units in total. Accordingly, a three phase MV-UPS system that includes a power converter having three legs may include 48 fourth power converters 614.

As noted hereinabove, the fourth power converters 614 may include a bidirectional converter, a unidirectional converter, or both the bidirectional converter and the unidirectional converter. Also, if the fourth power converter 614 is a unidirectional converter, a charging unit may be employed to charge the energy source 608. Furthermore, the fourth power converters 614 and the transformer 612 having the primary winding 611 and the secondary windings 613 may be isolated from the other components of the system 600.

In one non-limiting example, the transformer 612 and the plurality of fourth power converters 614 may be configured to form a modular unit 618. To that end, the transformer 612 and the plurality of fourth power converters 614 may be enclosed in an isolated container to form the modular unit 618. In one example, the modular unit 618 may be a mechanical box. The modular unit 618 may be configured to provide isolation from the other components of the system 600. In one example, the modular unit 618 may be configured to provide isolation from the voltage across a DC link (not shown). Furthermore, each fourth power converter 614 may also be isolated from the other fourth power converters 614.

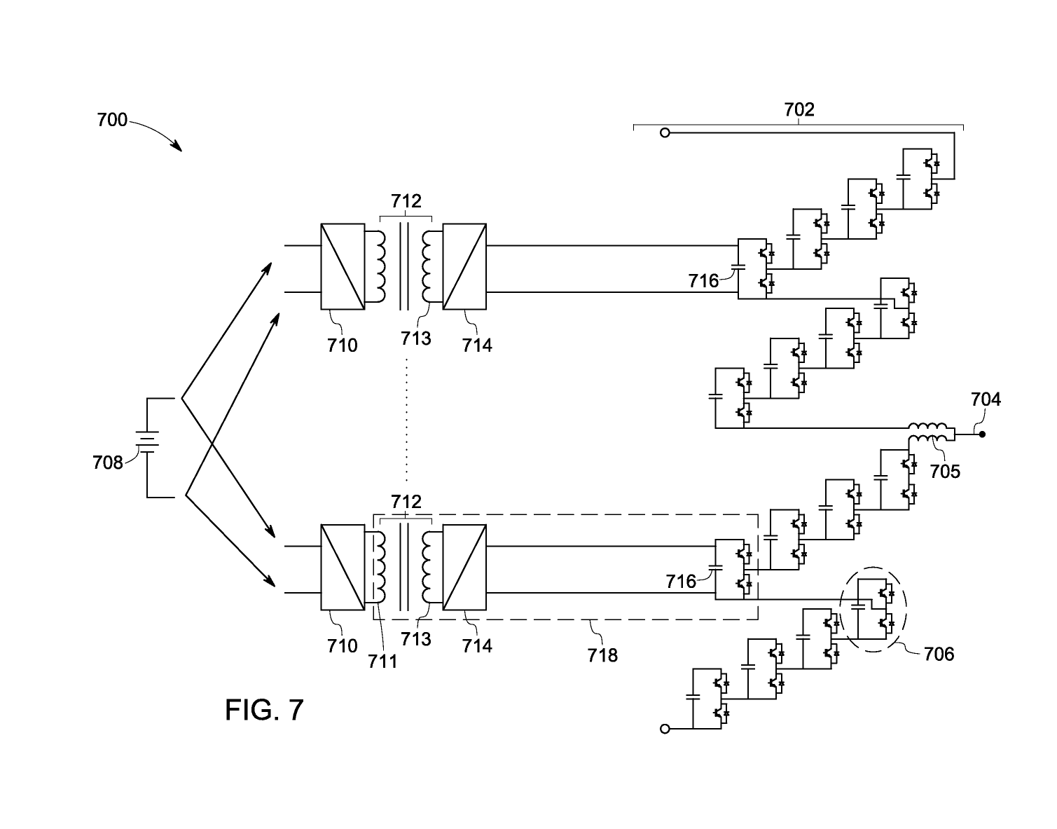

Turning now to FIG. 7, a diagrammatical representation 700 of an exemplary embodiment of a portion of the MV-UPS system 100 of FIG. 1, according to aspects of the present disclosure, is depicted. The example of FIG. 7 may include a leg 702 of a power converter, such as the second power converter 106 of FIG. 1. The leg 702 may further be operatively coupled to a third bus 704 via an inductor 705. The third bus 704 may include an alternating current phase such as AC phase A, AC phase B, and AC phase C. The leg 702 of the power converter may include a plurality of switching units 706 operatively coupled in series.

Furthermore, in accordance with exemplary aspects of the present disclosure, the system 700 may include a common energy source 708, a plurality of third power converters 710, a plurality of transformers 712, and a plurality of fourth power converters 714. Each transformer 712 may include a corresponding primary winding 711 and secondary winding 713. In addition, the common energy source 708 may be operatively coupled to each of the plurality of third power converters 710. The energy source 708 may include a single battery, a plurality of batteries operatively coupled in series and/or parallel, and the like. Moreover, each of the plurality of third power converters 710 may be operatively coupled to a corresponding transformer 712. Also, a number of fourth power converters 714 in one leg may be substantially equal to a number of switching units 706. Also, each transformer 712 may be operatively coupled to a corresponding fourth power converter 714. Also, each fourth power converter 714 may be operatively coupled to a corresponding switching unit 706. In particular, the fourth power converter 714 may be coupled across a capacitor 716 of the corresponding switching unit 706.

In the example of FIG. 7, a combination of the transformer 712, the fourth power converter 714, and the corresponding switching unit 706 may form a modular unit 718. The system 700 may include a plurality of such modular units 718. These modular units 718 may be isolated from other modular units 718 to provide a desired voltage isolation. In particular, the transformer 712 in the modular units 718 may be configured to provide the desired voltage isolation. Also, the modular unit 718 may be isolated from the other components of the system 700. In one example, the modular unit 718 may be configured to withstand voltage across the DC link (not shown). In accordance with exemplary aspects of the present disclosure, the MV-UPS, such as the MV-UPS 100 of FIG. 1 that includes the system of FIG. 7 may be designed to operate across a range of voltages by varying a number of modular units 718 that may be coupled in series.

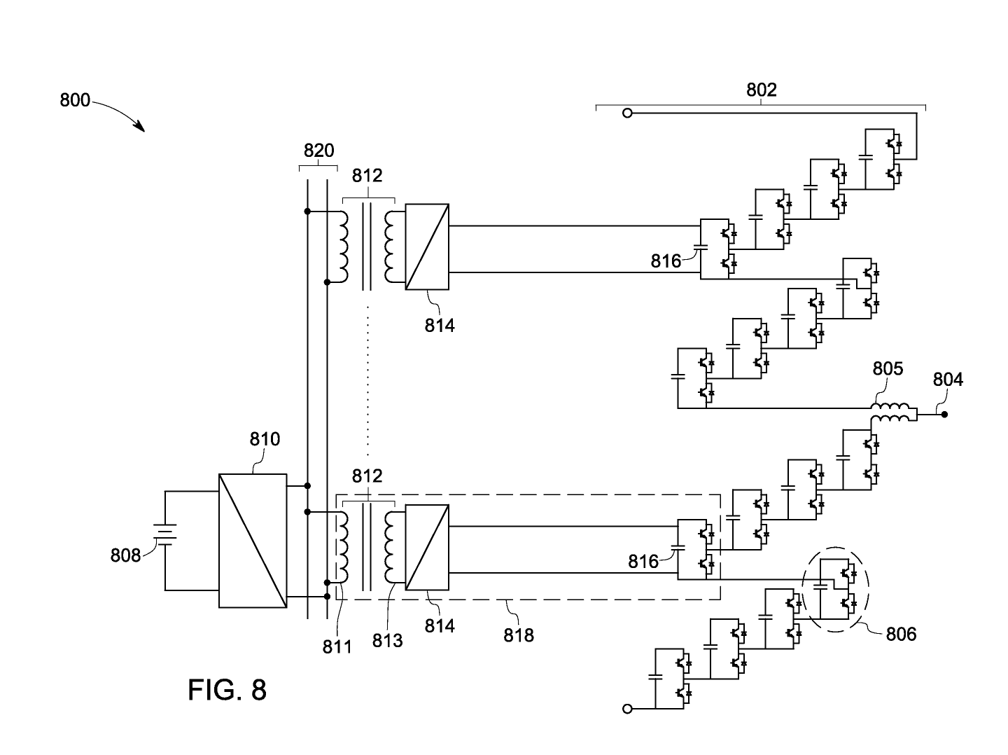

FIG. 8 is a diagrammatical representation 800 of yet another exemplary embodiment of a portion of MV-UPS system 100 of FIG. 1, according to aspects of the present disclosure. The example of the system 800 depicted in FIG. 8 includes a leg 802 operatively coupled to a third bus 804 via an inductor 805. Furthermore, the leg 802 may include a plurality of switching units 806 operatively coupled in series. A common energy source 808 may be operatively coupled to a common third power converter 810. Moreover, the system 800 may also include a plurality of transformers 812. The third power converter 810 may be coupled to primary windings 811 of the plurality of transformers 812 via a common line 820. A secondary winding 813 of the plurality of transformers 812 may be operatively coupled to a corresponding fourth power converter 814. The fourth power converter 814 may be operatively coupled to a corresponding switching unit 806. More particularly, the fourth power converter 814 may be operatively coupled across a capacitor 816 associated with the corresponding switching unit 806. In one example, the number of fourth power converters 814 may be substantially equal to the number of switching units 806 in the leg 802.

In one example, all legs of the power converter, such as the second power converter 106 of FIG. 1 may include equal number of switching units 806. A transformer 812, a fourth power converter 814 and a corresponding switching unit 806 may form a modular unit 818. Each modular unit 818 may be isolated from the other modular units 818. Also, the modular units 818 provide isolation from the other components of the system 800. In one non-limiting example, the modular units 818 provide isolation from the voltage across a DC link (not shown).

For the ease of representation, examples of FIGS. 3-8 depict only one leg of the second power converter. Although the examples of FIGS. 3-8 represent a MV-UPS system, use of similar configurations for low voltage UPS systems and high voltage UPS systems is also contemplated.

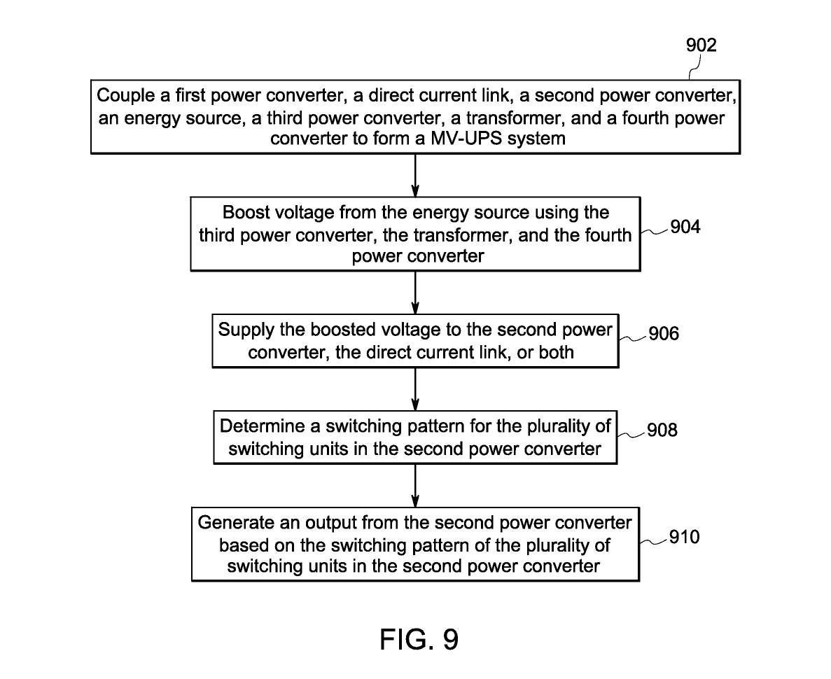

Turning now to FIG. 9, a flow chart 900 representing a method of operating an MV-UPS system, such as the MV-UPS system 100 of FIG. 1, according to aspects of the present disclosure, is presented. FIG. 9 will be explained with reference to FIGS. 1-2. The method begins at step 902, where the first power converter 102 may be coupled to the second power converter 106 via the first bus 116 and the second bus 118. Furthermore, the DC link 104 may be coupled between the first bus 116 and the second bus 118. Also, the energy source 108 may be coupled to the DC link 104, a switching unit 210 of the second power converter 106, or a combination thereof. As noted hereinabove, the energy source 108 may include a battery. The first power converter 102, the second power converter 106, the DC link 104, the third power converter 110, the transformer 112, and the fourth power converter 114 may be coupled to form the exemplary MV-UPS 100 of FIG. 1.

Furthermore, at step 904, voltage from the energy source 108 may be boosted by using one or more of the third power converter 110, the transformer 112, and the fourth power converter 114 to supply voltage across the DC link 104. At step 906, the boosted voltage generated at step 904 may be supplied as an input to the second power converter 106 and/or the DC link 104. More particularly, the boosted voltage generated at step 904 may be supplied to the switching units 210 of the second power converter 106. It may be noted that the step 904 is representative of a backup mode of operation. As previously noted, in the backup mode of operation, power is supplied from the energy source 108 to the second power converter 106. Alternatively, the power may be supplied from the power source and/or grid 120 to the second power converter 106 via the first power converter 102 and the DC link 104. This mode of operation may also be referred to as the utility mode of operation.

Subsequent to step 906, a switching pattern for the plurality of switching units in the second power converter 106 may be determined, as indicated by step 908. The switching pattern of the plurality of switching units may be determined by employing a controller, such as the controller 124 of FIG. 1. Moreover, the switching pattern corresponding to the plurality of switching units may be used to control the switching of the fully controllable semiconductor switches in the plurality of switching units. In addition, the switching pattern of the plurality of switching units of the first power converter 102 may also be determined.

Moreover, at step 910, the second power converter 106 is configured to generate an output. It may be noted that the output generated by the second power converter 106 may be dependent on the switching pattern on the plurality of switching units in the second power converter 106. The output generated by the second power converter 106 may include a line parameter. In one non-limiting example, the line parameter may include a medium voltage AC waveform. In yet another example, the line parameter may include a controllable AC current waveform.

Furthermore, the foregoing examples, demonstrations, and process steps such as those that may be performed by the system may be implemented by suitable code on a processor-based system, such as a general-purpose or special-purpose computer. It should also be noted that different implementations of the present technique may perform some or all of the steps described herein in different orders or substantially concurrently, that is, in parallel. Furthermore, the functions may be implemented in a variety of programming languages, including but not limited to C++ or Java. Such code may be stored or adapted for storage on one or more tangible, machine readable media, such as on data repository chips, local or remote hard disks, optical disks (that is, CDs or DVDs), memory or other media, which may be accessed by a processor-based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in the data repository or memory.

Various embodiments of the medium voltage UPS and the method of operating the MV-UPS system are described hereinabove aid in improving operational efficiency of a data center. Furthermore, the MV-UPS system results in a lower value of current, thereby reducing cabling cost. Also, use of low voltage switches in the MV-UPS system aids in reducing the cost of the MV-UPS systems. Moreover, the MV-UPS systems may find application in data centers, a hospital, and the like.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof.

1. A medium voltage uninterruptible power supply system, comprising:
a first power converter operatively coupled between a first bus and a second bus;
a second power converter operatively coupled to the first power converter via the first bus and the second bus, wherein the second power converter comprises at least three legs, wherein the at least three legs comprise a plurality of switching units, and wherein the plurality of switching units comprises at least two semiconductor switches and an energy storage device;
a direct current link operatively coupled between the first bus and the second bus; and
an energy source operatively coupled to the second power converter, the direct current link or both the second power converter and the direct current link via one or more of a third power converter, a transformer, and a fourth power converter.

2. The system of claim 1, wherein the transformer and the fourth power converter are combined to form an isolated modular unit.

3. The system of claim 2, wherein the isolated modular unit further comprises at least one of the plurality of switching units of the second power converter.

4. The system of claim 1, wherein the direct current link comprises a plurality of capacitors operatively coupled in series.

5. The system of claim 1, wherein the energy source is operatively coupled to each of the plurality of switching units in the at least three legs of the second power converter via one or more of the third power converter, the transformer, and the fourth power converter.

6. The system of claim 1, wherein the first power converter comprises at least three legs, wherein the at least three legs comprise a plurality of switching units, and wherein the plurality of switching units comprise at least two semiconductor switches and an energy storage device.

7. The system of claim 6, further comprising a controller configured to determine a switching pattern for the plurality of switching units of the first power converter and the plurality of switching units of the second power converter.

8. The system of claim 1, wherein the transformer, the third power converter, and the fourth power converter are configured to boost voltage of the energy source.

9. The system of claim 1, further comprising a bypass branch operatively coupled across the first power converter and the second power converter.

10. The system of claim 9, wherein the bypass branch comprises an electromechanical switch, a semiconductor switch, or a combination thereof.

11. The system of claim 1, wherein the at least two semiconductor switches comprise an insulated gate bipolar transistor, a metal oxide semiconductor field effect transistor, a field-effect transistor, an injection enhanced gate transistor, an integrated gate commutated thyristor, or combinations thereof.

12. The system of claim 1, wherein the at least two semiconductor switches comprise a gallium nitride based switch, a silicon carbide based switch, a gallium arsenide based switch, or combinations thereof.

13. The system of claim 1, wherein the at least three legs of the second power converter comprise a first portion operatively coupled to a second portion via a third bus.

14. The system of claim 1, wherein the plurality of switching units in the at least three legs of the second power converter is operatively coupled in series.

15. The system of claim 1, wherein the energy source comprises at least one battery.

16. The system of claim 1, further comprising a charging unit operatively coupled to the energy source and configured to charge the energy source.

17. The system of claim 1, wherein the third power converter comprises a low frequency resonant converter, a high frequency phase shifted resonant converter, an unidirectional converter, a bidirectional converter, or combinations thereof.

18. The system of claim 1, wherein the fourth power converter comprises a rectifier, a bidirectional converter, a unidirectional converter, or combinations thereof.

19. The system of claim 1, wherein the transformer comprises a low frequency transformer, a high frequency transformer, a graded insulation transformer, a transformer with uniform insulation, a single phase transformer, a three phase transformer, a multi-phase transformer, a multiple-winding transformer, or combinations thereof.

20. A method, comprising:
coupling a first power converter to a second power converter via a first bus and a second bus, wherein the second power converter comprises at least three legs, wherein the at least three legs comprise a plurality of switching units, and wherein the plurality of switching units comprises at least two semiconductor switches and an energy storage device;
connecting a direct current link between the first bus and the second bus;
operatively coupling an energy source to the second power converter, the direct current link, or both the second power converter and the direct current link via one or more of a third power converter, a transformer, and a fourth power converter;
determining a switching pattern for the plurality of switching units in the second power converter; and
generating an output at an output terminal of the second power converter based on the switching pattern of the plurality of switching units of the second power converter.

21. The method of claim 20, further comprising charging the energy source via one or more of the first power converter, the direct current link, the third power converter, the transformer, the fourth power converter, and a charging unit.

22. The method of claim 20, further comprising:
boosting voltage from the energy source via the third power converter, the transformer, and the fourth power converter; and
supplying the boosted voltage to one or more of the second power converter, the direct current link, and the plurality of switching units of the second power converter.

23. A medium voltage uninterruptible power supply system, comprising:
a first power converter operatively coupled between a first bus and a second bus;
a second power converter operatively coupled to the first power converter via the first bus and the second bus, wherein the second power converter comprises at least three legs, wherein the at least three legs comprise a plurality of switching units, and wherein the plurality of switching units comprises at least two semiconductor switches and an energy storage device;
a direct current link operatively coupled between the first bus and the second bus, wherein the direct current link comprises a plurality of capacitors operatively coupled in series; and
an energy source operatively coupled to the plurality of capacitors of the direct current link, each of the plurality of switching units of the second power converter, or a combination thereof via one or more of a third power converter, a transformer, and a fourth power converter.
